(19) United States
(12) Patent Application Publication
(10) Pub. No.: US 2020/0382248 A1
(43) Pub. Date: Dec. 3, 2020

(54) BACKHAUL TRANSMISSION BETWEEN NETWORK DEVICES

(71) Applicant: Nokia Solutions and Networks Oy, Espoo (FI)

(72) Inventors: Xiaobing LENG, Shanghai (CN); Dawei WANG, Shanghai (CN); Junrong GU, Shanghai (CN); Dongyao WANG, Shanghai (CN); Gang SHEN, Shanghai (CN)

(21) Appl. No.: 16/764,185

(22) PCT Filed: Nov. 20, 2017
(86) PCT No.: PCT/CN2017/111903

§ 371 Date: May 14, 2020

(51) Int. Cl. H04L 5/00; H04L 1/00

(52) U.S. Cl. CPC H04L 5/0044; H04L 5/0007; H04W 84/047; H04L 5/0094; H04L 1/0068

(57) ABSTRACT

Embodiments of the present disclosure relate to a method and device for backhaul transmission. In example embodiments, the first network device transmits uplink (UL) data to a second network device in a first UL backhaul link, the first UL backhaul link being scheduled by the first network device. The second network device is located in upstream of the first network device. The first network device receives downlink (DL) data from the second network device in a first DL backhaul link. The first DL backhaul link is scheduled by the second network device. In this way, the transmission latency may be reduced, and the transmission efficiency may be improved.

### TECHNICAL FIELD

Embodiments of the present disclosure generally relate to the field of telecommunications, and in particular, to a method and device for backhaul transmission.

### BACKGROUND

High bandwidth (or capacity) and low latency requirements have been specified for the fifth generation (5G) network. Enhanced Mobile Bandwidth (eMBB) traffic requires the high bandwidth (or capacity), and Ultra-Reliable and Low Latency Communications (URLLC) traffic requires the low latency, for example. In order to fulfill the low latency requirements of the URLLC traffic, the URLLC packets (or bursts) are allowed to be inserted into the on-going eMBB bursts in a downlink (DL) radio access. In the context of the present disclosure, the radio access refers to communication between a base station (BS or network device) and user equipment (UE or terminal device) served by the network device. The DL radio access refers to the communication from the network device to the terminal device.

In an uplink (UL) radio access, due to resource allocation limitation of the UE, the UE needs request the network device to allocate a resource for UL transmission. The resource request procedure may increase the latency. To this end, it is proposed to reserve periodical resources for UL URLLC bursts. However, resource waste may be caused if more resources are reserved. Furthermore, the less reserved resources may not meet the resource requirements of the URLLC bursts. Therefore, the UE may need to wait for one or even more transmission periods, and the higher latency may be induced.

In addition, wireless backhaul links between network nodes are proposed in the 5G networks. In the wireless backhaul links, the network nodes wirelessly communicate with each other for information forwarding. This wireless backhaul link, in particular, a multiple hop wireless backhaul link, allows a plurality of network nodes to be deployed flexibly in the network, and therefore provides user equipment (UEs) with efficient accesses to the network. Furthermore, this network deployment is more rapid and low-cost.

However, the forwarding of the URLLC traffic in wireless backhaul links, in particular in a multiple hop wireless backhaul link, may inevitably increase the latency of the URLLC traffic. At present, no approach of transmitting the low-latency traffic, such as the URLLC traffic, in the wireless backhaul links are specified in the third generation partner project (3GPP) standards.

### SUMMARY

In general, example embodiments of the present disclosure provide a method and device for backhaul transmission.

In a first aspect, a method implemented at a first network device is provided. According to the method, the first network device transmits uplink (UL) data to a second network device in a first UL backhaul link, the first UL backhaul link being scheduled by the first network device. The second network device is located in upstream of the first network device. The first network device receives downlink (DL) data from the second network device in a first DL backhaul link. The first DL backhaul link is scheduled by the second network device.

In a second aspect, a method implemented at a second network device is provided. The method comprises: transmitting downlink (DL) data to a first network device in a first DL backhaul link, the first DL backhaul link being scheduled by the second network device, and the second network device being located in upstream of the first network device; and receiving uplink (UL) data from the first network device in a first UL backhaul link, the first UL backhaul link being scheduled by the first network device.

In a third aspect, there is provided a network device. The network device comprises a processor and a memory including instructions. The instructions, when executable by the processor, cause the network device to perform the method according to the first or second aspect.

In a fourth aspect, there is provided a computer readable storage medium tangibly storing a computer program thereon. The computer program includes instructions which, when executed by at least one processor, cause the at least one processor to carry out the method according to the first or second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 shows an example communication network 100 in which embodiments of the present disclosure can be implemented;

FIG. 2 shows example resource scheduling for the first UL and DL backhaul links according to some embodiments of the present disclosure;

FIG. 3 shows example transmission postponing of the first type of UL data due to the insertion of the second type of the UL data according to some embodiments of the present disclosure;

FIG. 4 shows an example hybrid automatic repeat quest (HARQ) procedure of the second type of data according to some embodiments of the present disclosure;

FIGS. 5A-5E show example reuses of the frequency bands in out-band backhaul according to some embodiments of the present disclosure;

FIG. 6 shows an example reuse of the frequency bands in the in-band backhaul according to some embodiments of the present disclosure;

FIG. 7 shows a block diagram of the first network device according to some embodiments of the present disclosure;

FIG. 8 shows a block diagram of the second network device according to some embodiments of the present disclosure;

FIG. 9 shows a block diagram of the third network device 120 according to some embodiments of the present disclosure;

FIG. 10 shows a flowchart of an example method in accordance with some embodiments of the present disclosure;

FIG. 11 shows a flowchart of an example method in accordance with some other embodiments of the present disclosure; and

FIG. 12 shows a block diagram of a device 1200 suitable for implementing embodiments of the present disclosure.

Throughout the drawings, the same or similar reference numerals represent the same or similar element.

### DETAILED DESCRIPTION

Embodiments of the present disclosure will be described in more details with reference to the drawings. Although the drawings show some embodiments of the present disclosure, it is to be understood that the present disclosure may be implemented in various manners and should not be construed as being limited to the embodiments explained herein. On the contrary, the embodiments are provided for a more thorough and complete understanding of the present disclosure. It is to be understood that the drawings and embodiments of the present disclosure are only for the purpose of illustration, without suggesting any limitations on the protection scope of the present disclosure.

As used herein, the term “network device” refers to a base station or other entities or nodes having a particular function in a communication network. The term “base station” (BS) may represent a node B (NodeB or NB), an evolution node B (eNode B or eNB), a remote radio unit (RRU), a radio frequency head (RH), a remote radio head (RRH), a relay, or a low power node, such as a picocell or a femtocell, or the like. In the context of the present disclosure, the terms “network device” and “base station” are used interchangeably for the sake of discussion.

As used herein, the term “terminal device” or “user equipment” (UE) refers to any terminal devices capable of wireless communications with each other or with the base station. As an example, the terminal device may comprise a mobile terminal (MT), a subscriber station (SS), a portable subscriber station (PSS), a mobile station (MS) or an access terminal (AT), and the above devices mounted on a vehicle. In the context of the present disclosure, the terms “terminal device” and “user equipment” are used interchangeably for the sake of discussion.

As used herein, the term “uplink” or (UL) refers to a direction from a terminal device to a network device. UL data or control information refers to data or control information transmitted from the terminal device to the network device. The term “downlink” refers to a direction from a network device to a terminal device. DL data or control information refers to data or control information transmitted from the network device to the terminal device.

As used herein, the term “downstream” refers to a location closer to the terminal device's side. A downstream network device refers to a network device that is closer to the terminal device. The term “upstream” refers to a location farther away from the terminal device's side. A downstream network device refers to a network device that is farther away from the terminal device.

As used herein, the term “includes” and its variants are to be read as open terms that mean “includes, but is not limited to”. The term “based on” is to be read as “based at least in part on”. The term “one embodiment” is to be read as “at least one embodiment”. The term “a further embodiment” is to be read as “at least one further embodiment”. Definitions related to other terms will be presented in the following description.

As described above, the access transmission between the terminal device and network device are asymmetrical in the DL and UL directions. For example, in the DL direction, the URLLC bursts may be inserted into the on-going eMBB bursts and be transmitted in a mini-time slot (for example, shorter than a legacy time slot of 0.5 ms). In the UL direction, dedicated resources are conventionally reserved for the URLLC traffic, which may cause a resource waste or a higher latency.

Furthermore, the deployment of wireless backhaul links between network nodes, in particular, the deployment of multiple hop wireless backhaul links, may increase the latency of the URLLC traffic. There is no effective and efficient approach proposed for transmitting the low-latency traffic, such as the URLLC traffic, in the wireless backhaul links.

Embodiments of the present disclosure provide symmetrical backhaul transmission in backhaul links. Different from the asymmetrical access transmission in which both DL and UL transmissions are controlled by the network device, the symmetrical backhaul transmissions between two network devices are scheduled by both of the network devices. One of the two network devices schedules (or controls or maintains) a UL backhaul link for UL data transmission, and the other of the two network devices schedules (or controls or maintains) a DL backhaul link for DL data transmission.

This symmetrical transmission avoids a bandwidth request process of the terminal device and therefore reduces the latency. As such, both the UL and DL backhaul transmission can be scheduled, which is more flexible and efficient. Especially for the low latency traffic, the data may be forwarded by the network devices fast and efficiently in both UL and DL directions.

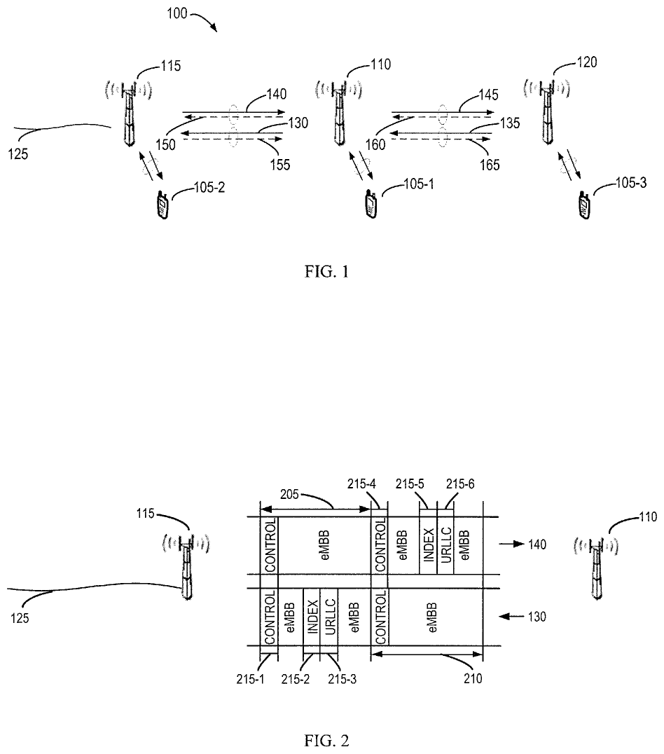

FIG. 1 shows an example communication network 100 in which embodiments of the present disclosure can be implemented. The network 100 includes three terminal devices 105-1, 105-2, and 105-3 (collectively referred to as a “terminal device 105”) and three network devices that include a first network device 110, a second network device 115, and a third network device 120. The terminal devices 105-1, 105-2, and 105-3 are located in three cells served by the three network devices 110, 115, and 120, respectively. It is to be understood that the numbers of network devices and terminal devices as shown in FIG. 1 is only for the purpose of illustration, without suggesting any limitations. The network 100 may comprise any suitable number of network devices or terminal devices.

The terminal devices 105-1, 105-2, and 105-3 may communicate with the first, second, and third network devices 110, 115, and 120 by using any suitable communication technology and following any suitable communication standard. Examples of the communication technology include, but are not limited to, Long Term Evolution (LTE), LTE Advanced (LTE-A), Orthogonal Frequency Division Multiplexing (OFDM), Wideband Code Division Multiple Access (WCDMA), Code Division Multiple Access (CDMA), Global System for Mobile (GSM), Wireless Local Area Network (WLAN), Worldwide Interoperability for Microwave Access (WiMAX) Bluetooth, Zigbee, and/or any other technologies either currently known or to be developed in the future.

In the network 100 as shown, the first network device 110 is in downstream of the second network device 115 and in upstream of the third network device 120. The second network device 115 connects via a fiber 125 to an outer network (not shown). The first network device 110 may be referred to as a relay network device, and the second network device 115 may be referred to as an anchor network device.

The network devices 110, 115, and 120 may communicate with each other in a first UL backhaul link 130, a second UL backhaul link 135 and a first DL backhaul link 140, and a second DL backhaul link 145. In the context of the present disclosure, a UL backhaul link is used to carry data or some control information in the UL direction (referred to as UL data or UL control information), and a DL backhaul link is used to carry data or some control information in the DL direction (referred to as DL data or DL control information). The communications between the network devices may use any suitable communication technology that is either currently known or to be developed in the future.

In various embodiments of the present disclosure, the first UL backhaul link 130 is scheduled by the first network device 110 to transmit UL data to the second network device 115. For example, the first network device 110 may control or schedule resources for the first UL backhaul link 130. The first UL backhaul link 130 may carry aggregated data or control information from the terminal device 105-1 and the third network device 120. The aggregated data may include different types of data and have different requirements, for example. Examples of the UL data may include eMBB data or massive machine type communications (MMTC) data having the high-bandwidth requirements, URLLC data having the low-latency requirements, and other types of data.

For a type of UL data (referred to as a “first type of UL data”), the first network device 110 may determine a UL resource for transmitting the first type of UL data in the first UL backhaul link 130. The UL resource may be reserved or dynamically allocated by the first network device 110 for the first UL backhaul link 130. By way example, for those periodical URLLC packets (or bursts), some resources may be reserved in the backhaul link. If a URLLC packet (or burst) arrives in align with a reserved slot, the URLLC packet can be transmitted immediately. Accordingly, it would be beneficial that these reserved slots synchronize with a transmission period of the URLLC bursts. For those non-nonsynchronous URLLC bursts, the resources may be preempted. Therefore, the pre-allocation and preempt of the resources can coexist over the backhaul link. If pre-configured slots are set, the receiving side may be informed of information about a size, location and period of the pre-configured slots. With this information, the receiving side may find and decode an indication the URLLC burst index in the pre-configured slots.

The UL resource may have any suitable size in a time/frequency/space dimension. The first network device 110 may use the UL resource to transmit the first type of UL data to the second network device 115 in the first UL backhaul link 130. As an example, control signaling for a time slot may be used to indicate the position and/or size of the backhaul resource.

In some embodiments, the first network device 110 may use only a part (referred to as a “first part”) of the UL resource for transmitting the first type of UL data and use a further part (referred to as a “second part”) of the UL resource for transmitting a further type of UL data (referred to as a “second type of UL data”). For example, if the second type of UL data is to be transmitted during the transmission of the first type of UL data, the first network device 110 may allocate the second part of the UL resource for the transmission of the second type of UL data.

The first and second parts of the UL resource may include any suitable portion of the UL resource. In an embodiment where the UL resource includes a time slot (referred to as a first time slot), the first and second parts of the UL resource may include two different sets of symbols in the first time slot (referred to a “first set of symbols” and a “second set of symbols”, respectively).

As described above, in addition to the UL data, the first UL backhaul link 130 may carry some control information. In some embodiments, when the first network device 110 uses the second part of the UL resource to transmit the second type of UL data to the second network device 115 in the first UL backhaul link 130, the first network device 110 sends control information associated with the second type of UL data to the second network device 115 in the first UL backhaul link 130 by using a third part of the UL resource. Similar to the first and second parts of the UL resource, the third part include any suitable portion of the UL resource. For example, in the embodiments where the UL resource includes a time slot, the third part of the UL resource may include one or more symbols of the time slot.

In the DL direction, the second network device 115 schedules the first DL backhaul link 140 to transmit DL data to the first network device 110. Similar to the UL data, the DL data may be of different types and have different requirements. In the symmetrical backhaul transmissions according to embodiments of the present disclosure, a DL resource allocated for transmitting the DL data in the first DL backhaul link 140 may also be shared between two different types of DL data (referred to as a “first type of DL data” and a “second type of DL data”, respectively).

FIG. 2 shows example resource scheduling for the first UL and DL backhaul links 130 and 140 according to some embodiments of the present disclosure. In this example, the first type of UL data is the eMBB data, and the second type of UL data is the URLLC data. The eMBB data is transmitted in a time slot granularity, and the URLLC data is transmitted in a symbol granularity. Specifically, in the first UL backhaul link 130, the first network device 110 transmits the UL eMBB traffic (for example, UL eMBB data) to the second network device 115 in two time slots 205 and 210.

As shown, the UL URLLC traffic is inserted into the on-going eMBB traffic. The UL URLLC traffic includes control information in the symbol 215-2 and the later UL URLLC data in the symbol 215-3. In this example, the control information is carried in an index which may include a preamble, a size of a data packet (or burst), and/or a modulation/coding mode used for the transmission of the UL URLLC data. The index may be used to detect and extract the UL URLLC data at the receiving side.

The aligned timing is used in both the UL and DL directions. In the first DL backhaul link 140, the second network device 115 transmits the DL eMBB data to the first network device 110 in the time slots 205 and 210. Similar to the UL direction, the DL URLLC data and related control information (for example, an index) are inserted into the symbols 215-5 and 215-6.

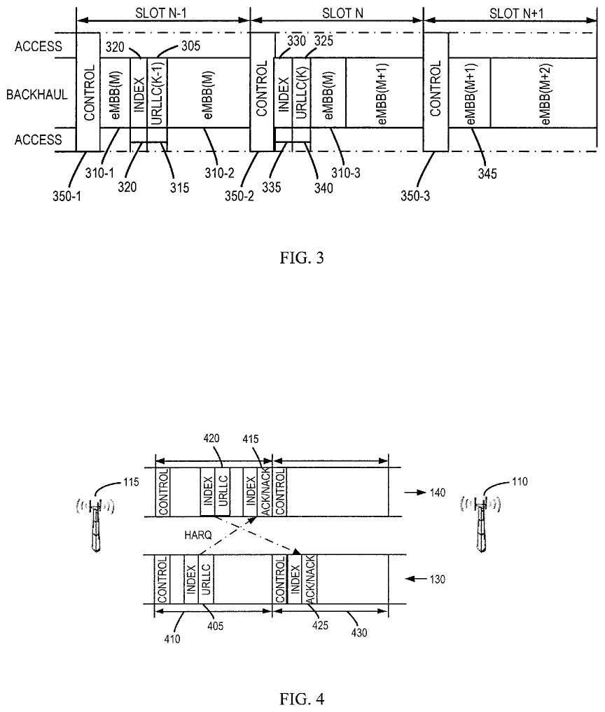

At the transmitting side, when the URLLC traffic is inserted into the eMBB traffic, a part of the eMBB data will be delayed to be transmitted in a next time slot. FIG. 3 shows example transmission postponing of the first type of UL data due to the insertion of the second type of the UL data according to some embodiments of the present disclosure. Similar to the example discussed with reference to FIG. 2, the first type of UL data is the eMBB data, and the second type of the UL data is the UL URLLC data.

As shown in FIG. 3, a URLLC packet (or burst) K−1 (denoted by 305) occupies some of the resources reserved for an eMBB packet (or burst) M (denoted by 310-1, 310-2, and 310-3) in the first UL haul link 130. As shown, the URLLC packet K−1 is inserted into a first portion of the eMBB packet M (denoted by 310-1 and 310-2) in a symbol 315 of a time slot N−1. An index 320 for the URLLC packet K−1 is sent in a symbol 320 of the time slot N−1. In addition to the eMBB and URLLC packets, UL data or control information from the access network is also transmitted in this time slot. The backhaul eMBB traffic and URLLC traffic only occupy the resource space reserved for the backhaul and not impact the transmission in the access network.

Due to the insertion of the URLLC packet K−1, a second portion 310-3 of the eMBB packet M is postponed to the next time slot N. A UL URLLC packet K (denoted by 325) and a related index 330 are transmitted in two time slots 335 and 340 of the time slot N. Likewise, due to the addition of the URLLC packet K and the second part 310-3 of the eMBB packet M, a portion of an eMBB packet M+1 (denoted by 345) is postponed to the next time slot N+1, as shown.

In the embodiments where a second portion of the first UL data packet is delayed to be transmitted in at least one symbol of the second time slot in the first UL backhaul link 130, the first network device 110 may send an indication of the number of UL data packets of the first type to the second network device 115 in a further symbol of the second time slot in the first UL backhaul link 130. For example, as shown in FIG. 3, the control signaling 350-1, 350-2, and 350-3 (collectively referred to as “control signaling 350”) for the time slots N−1, N and N+2 may be used to indicate the status of the eMBB packets (as the data packet of the first type) in the respective time slots N−1, N and N+2. As an example, the value “0” of the control signaling 350 means that there is no eMBB packet in the current time slot. The value “1” of the control signaling 350 means that there is one eMBB packet (a postponed portion of a packet or a new packet) in the current time slot. The value “2” of the control signaling 350 means there are two eMBB packets, including (a postponed portion of a packet or a new packet, in the current time slot. The control signaling 350 may not indicate the URLLC packet as the URLLC traffic typically arrives after the control signaling 350 has been sent.

At the receiving side, the second network device 115 may use the control signaling 350 to demodulate and decode the eMBB packet(s) in a period (referred to as a “first period”), such as a time slot. The second network device 115 may also search the URLLC packet in a shorter period (referred to as a “second period”). If the index related to the URLLC packet is sent at the transmitting side, the second network device 115 may search the index in the second period. Once finding the index, the URLLC packet will be extracted, for example, from an OFDM symbol stream. After that, the second network device 115 may continue to receive the subsequent eMBB packets, which may last to the next time slot.

By taking the eMBB data as an example of the first type of UL data and the URLLC data as an example of the second type of UL data, the first period is a long transmission time interval (TTI) period to schedule the eMBB data, and the second period is a short TTI period to schedule the URLLC data. The long scheduling period may be a slot-level period (for example, 7 symbols or 14 symbols). The short scheduling period may be a symbol-level period (for example, 2 or 3 symbols). The long period is used for the eMBB data to reduce signaling overhead and achieve high resource efficiency. The short period may guarantee the URLLC data scheduled in a minimum waiting time to achieve the low transmission latency.

In some embodiments, in response to transmitting the second type of UL data in a symbol of a time slot, the first network device 110 may receive acknowledgement information, such as positive/negative acknowledgement (ACK/NACK), associated with the second type of UL data from the second network device 115 in a predetermined time interval in the first DL backhaul link 140. The predetermined time interval is shorter than a threshold interval (for example, a time slot) to reduce the latency. Likewise, in the opposite direction, the second network device 115 may receive the ACK/NACK associated with the second type of UL data from the first network device 110 in a time interval shorter than a threshold interval (for example, a time slot) in the first DL backhaul link 140.

FIG. 4 shows an example hybrid automatic repeat quest (HARQ) procedure of the second type of data according to some embodiments of the present disclosure. In this example, the second type of data is the URLLC data. The timing of the HARQ procedure is based on a symbol granularity. After the first network device 110 transmits the UL URLLC data in a symbol 405 of a time slot 410 in the first UL backhaul link 130, the first network device 110 may receive the corresponding ACK/NACK in a symbol 415 of the time slot 410 in the first DL backhaul link 140. In the opposite direction, after the second network device 115 transmits the DL URLLC data in a symbol 420 of the time slot 410, the second network device 115 may receive the corresponding ACK/NACK in a symbol 425 of a time slot 430.

Both the UL and DL HARQ procedures are completed within one time slot. Compared with a conventional HARQ procedure based on a slot granularity (for example, several time slots), this rapid HARQ mechanism may significantly reduce the backhaul transmission latency for URLLC traffic.

Still with reference to FIG. 1, in the network 100, after receiving the DL data from the second network device 115, the first network device 110 also transmits the DL data to the third network device 120 in the second DL backhaul link 145 (referred to as a “second DL backhaul link”). The second DL backhaul link 145 is scheduled by the first network device 110. Furthermore, the first network device 110 receives the UL data from the third network device 120 in the second UL backhaul link 135 scheduled by the third network device 120.

It is to be understood that three network devices 110, 115 and 120 are shown only for the purpose of illustration, without suggesting any limitations. In some implementations, the network 100 may include a further network device (referred to as a “fourth network device”) in upstream of the second network device 115. The second network device 115 may communicate UL/DL data with the fourth network device in corresponding UL/DL backhaul link.

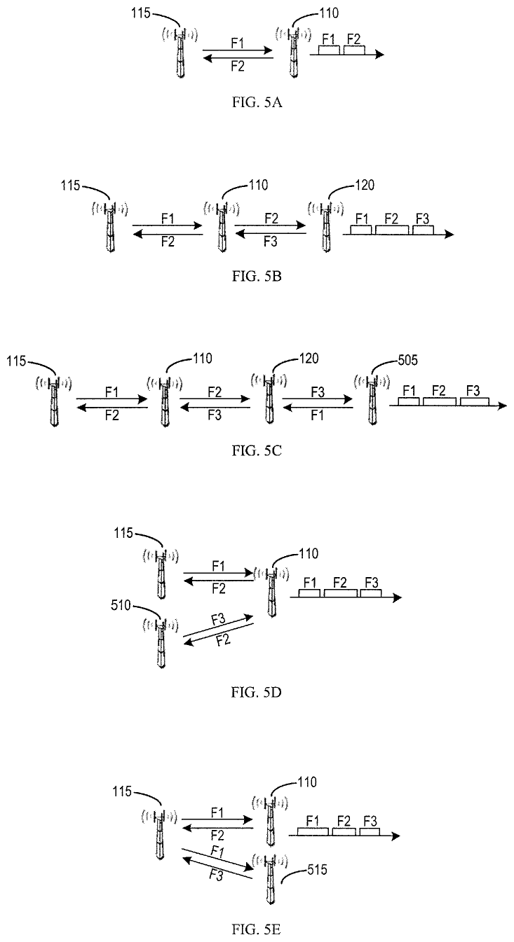

In some embodiments, some frequency bands for different backhaul links may be reused to increase the frequency efficiency. FIGS. 5A-5E show example reuses of the frequency bands in out-band backhaul according to some embodiments of the present disclosure. In the context of the present disclosure, the out-band backhaul means that the backhaul transmission operates in frequency bands outside of the access transmission.

As shown, the DL and UL backhaul links between any two network devices should operate (or word) in orthogonal frequency bands to avoid interferences between the two links. For example, the DL and UL backhaul links between the first and second network devices 110 and 115 operate in orthogonal frequency bands F1 and F2.

The backhaul links scheduled by one network device may operate in the same frequency band to increase the frequency efficiency. For example, as shown in FIGS. 5B and 5C, both the UL and DL backhaul links scheduled by the first network device 110 operate in the frequency band F2. Both the UL and DL backhaul links scheduled by the third network device 120 operate in a frequency band F3. Furthermore, as shown in FIG. 5D, the UL backhaul links between the first network device 110 and both the second network device 115 and a network device 510 operates in the frequency band F2. In FIG. 5E, the DL backhaul links between the second network device 115 and both the first network device 110 and a network device 515 operates in the frequency band F1.

The backhaul links scheduled by different network devices may operate in orthogonal frequency bands. For example, as shown in FIG. 5B, the backhaul links scheduled by the first, second and third network devices 110, 115 and 120 operate in the frequency bands F2, F1 and F3, respectively.

If two network devices are located far away, their backhaul links may use the same frequency band. For example, as shown in FIG. 5C, the DL backhaul link scheduled by the second network device 115 and a UL backhaul link scheduled by a network device 505 both operate in the frequency band F1 since the distance between the second and third network devices 115 and 120 are far enough.

In some embodiments, in in-band backhaul, both backhaul links and access links may share common resources. In the context of the present disclosure, the in-band backhaul means that the backhaul transmission operates within the frequency bands of the access transmissions. For example, the reserved backhaul resources may be shared by DL access transmission when the backhaul transmission is in a low load state.

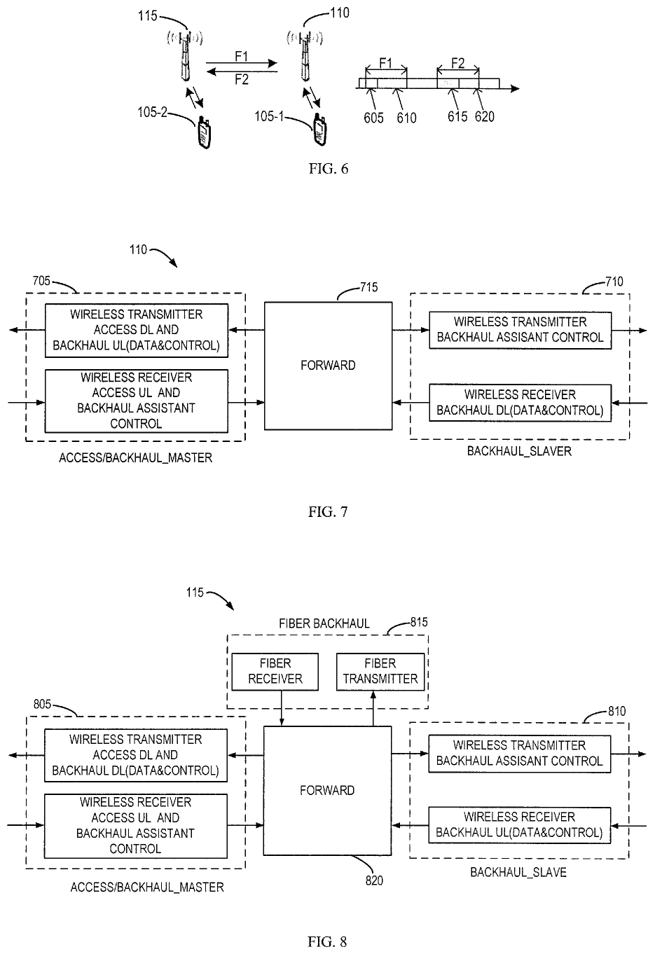

FIG. 6 shows an example reuse of the frequency bands in the in-band backhaul according to some embodiments of the present disclosure. The frequency bands F1 and F2 are reserved for the backhaul transmission. The reserved backhaul resources may be shared among the backhaul transmission and the access transmission to improve resource utilization. As shown, the reserved frequency band F1 is shared by the DL backhaul transmission 605 and the DL access transmission 610 of the second network device 115. The reserved frequency band F2 is shared by the UL backhaul transmission 615 and the DL access transmission 620 of the first network device 110.

In order to simply a frequency plan, dedicated frequency resources may be reserved for each backhaul link. The reserved frequencies may be sufficient to guarantee the corresponding backhaul transmission. The reservation may consider the traffic type. As an example, the backhaul bandwidth may be calculated as below:

Backhaul_bandwidth=ΣConcurrent_factor×Bandwidth_of_URLLC_burst+average_bandwidth_of_eMB

At the right side of the above equation, the former item will guarantee the latency requirements of the URLLC traffic, and the later one will guarantee the capacity requirements of the eMBB traffic. Concurrent_factor is a value (<=1) to indicate a concurrent degree of multiple URLLC connections. This value may be determined based on statistics of history URLLC connections.

Next, still with reference to FIG. 1, there are a UL assistant backhaul link 150 and a DL assistant backhaul link 155 between the first and second network devices 110 and 115. These two assistant backhaul links 150 and 155 are used to transmit a part of control information that may have less capacity and latency requirements. The part of control information may include an initial backhaul setup message, a HARQ response for the eMBB traffic, and the like.

FIG. 7 shows a block diagram of the first network device 110 according to some embodiments of the present disclosure. As shown, the first network device 110 includes an access/backhaul_master module 705 and a backhaul_slave module 710. The first network device 110 also includes a forwarding module 715 that implements information forwarding between the access/backhaul_master module 705 and backhaul_slave module 710.

In addition to the UL/DL access transmission with the terminal device 105-1, the access/backhaul_master module 705 may implement UL backhaul data transmission. At this time, an anchor network device or an upstream network device may be considered as a special terminal device of the first network device 110. The first network device 110 may schedule its DL resource for the backhaul UL data and only schedule a little UL resource for some necessary backhaul control information such as the backhaul assistant control information.

The backhaul_slave module 710 may be only used for receiving the backhaul DL data. At this time, the first network device 110 may be considered as a special UE of the upstream node, such as the second network device 115. The DL channels of the first network device 110 may be used for backhaul DL data, and its UL channels may be only used for some backhaul assistant control information.

Both the backhaul DL data transmission and the backhaul UL data transmission operate in FDD DL frequency bands. The backhaul DL data transmission may utilize the DL frequency resource of the upstream network device, and the backhaul UL data transmission may utilize the DL frequency resource of the first network device 110. The backhaul UL and backhaul DL should use orthogonal resources.

FIG. 8 shows a block diagram of the second network device 115 according to some embodiments of the present disclosure. As shown, the second network device 115 includes an access/backhaul_master module 805 and a backhaul_slave module 810. The second network device 115 also includes a fiber backhaul module 815 and a forwarding module 820.

In addition to the UL/DL access transmission with the terminal device 105-2, the access/backhaul_master module 805 may also implement the backhaul DL data transmission. But this module doesn't participate in the backhaul UL data transmission. For this module, the downstream network device, such as the first network device 110, is considered as a special terminal device, which only receives backhaul DL data. The second network device 115 may schedule its DL resource for backhaul DL data, but only schedule a little UL resource for backhaul transmission. The UL resource is only used for some backhaul assistant control information, such as the eMBB ACK/NACK feedback, and initial backhaul joining of the downstream network device, and the like.

The backhaul_slave module 810 may be only used for receiving the backhaul UL data. At this time, the second network device 115 is considered as a special terminal device of the downstream network device, such as the first network device 110. Similarly, the backhaul_slave module 810 doesn't participate in the DL backhaul data transmission. The downstream network device may schedule its DL resource for the backhaul UL data, but only schedule a little UL resource for the backhaul transmission. The UL resource is only used for some backhaul assistant control information.

Both the backhaul DL data transmission and the backhaul UL data transmission operate in FDD DL frequency bands. The backhaul DL data transmission may utilize anchor the DL frequency resource of the second network device 115, and the backhaul UL data transmission may utilize the DL frequency resource of the downstream network device, such as the first network device 110. In order to avoid interferences between the UL and DL backhaul links and between the access link and the backhaul like, the first and second network devices 110 and 115 may be coordinated to guarantee orthogonal resource allocations among these transmissions.

FIG. 9 shows a block diagram of the third network device 120 according to some embodiments of the present disclosure. As shown, the third network device 120 includes an access/backhaul_master module 905, a backhaul_slave_downstream module 910 and a backhaul_slave_upstream module 915. The third network device 120 also includes a forwarding module 920.

The access/backhaul_master module 905 implements local accesses, transmits the backhaul DL data to a downstream network device and transmits the backhaul UL data to an upstream network device such as the first network device 110. The access/backhaul_master module 905 may consider the downstream and upstream network devices as two special terminal devices. They only receive backhaul data. In addition, this module only receives some backhaul assistant control signaling from the upstream and downstream network devices.

The backhaul_slave_downstream module 910 and the backhaul_slave_upstream module 915 are used to receive the backhaul UL data from the downstream network device and the backhaul DL data from upstream network device, respectively. Just like above description, these two modules may be considered as two special terminal devices of the downstream and upstream network devices.

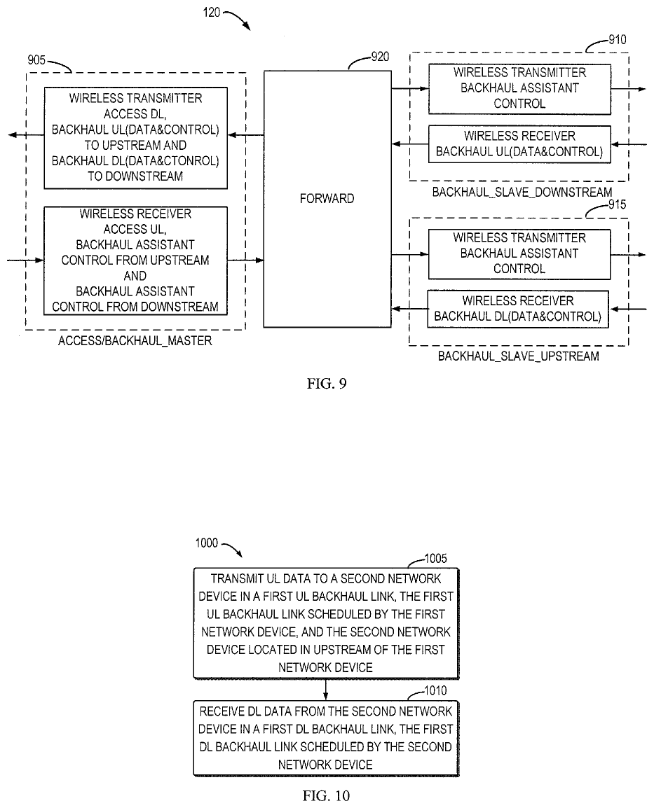

FIG. 10 shows a flowchart of an example method 1000 in accordance with some embodiments of the present disclosure. The method 1000 can be implemented at the first network device 110 as shown in FIG. 1. For the purpose of discussion, the method 1000 will be described with reference to FIG. 1.

At block 1005, the first network device 110 transmits uplink (UL) data to the second network device 115 in the first UL backhaul link 130. The first UL backhaul link is scheduled by the first network device 110. The second network device 115 is located in upstream of the first network device 110. At block 1010, the first network device 110 receives downlink (DL) data from the second network device 115 in the first DL backhaul link 140. The first DL backhaul link 140 is scheduled by the second network device 115.

In some embodiments, the UL data includes a first type of UL data. The first network device 110 may determine a UL resource for transmitting the first type of UL data in the first UL backhaul link 130. The first network device 110 may transmit, using at least a first part of the UL resource, the first type of UL data to the second network device 115 in the first UL backhaul link 130.

In some embodiments, the UL data further includes a second type of UL data. The second type is different from the first type. The first network device 110 may allocate a second part of the UL resource for transmitting the second type of UL data in the first UL backhaul link 130. The second part of the UL resource is different from the first part of the UL resource. The first network device 110 may transmit, using the second part of the UL resource, the second type of UL data to the second network device 115 in the first UL backhaul link 130.

In some embodiments, the UL resource includes a first time slot. The first part of the UL resource includes a first set of symbols in the first time slot, and the second part of the UL resource includes a second set of symbols in the first time slot. The second set of symbols are different from the first set of symbols.

In some embodiments, the UL resource further includes a second time slot subsequent to the first time slot. The first type of UL data includes a first UL data packet of the first type. The first network device 110 may transmit a first portion of the first UL data packet to the second network device 115 in the first set of symbols in the first UL backhaul link 130. The first network device 110 may transmit a second portion of the first UL data packet to the second network device 115 in at least one symbol of the second time slot in the first UL backhaul link 130.

In some embodiments, the first network device 110 may send an indication of the number of UL data packets of the first type to the second network device in a further symbol of the second time slot in the first UL backhaul link 130.

In some embodiments, the first network device 110 may send, using a third part of the UL resource, control information associated with the second type of UL data to the second network device 115 in the first UL backhaul link 130. The control information is to be used by the second network device 115 for receiving the second type of UL data.

In some embodiments, the UL resource is reserved for the first UL backhaul link.

In some embodiments, the first network device 110 may receive, in response to transmitting the second type of UL data, acknowledgement information associated with the second type of UL data from the second network device 115 in a predetermined time interval in the first DL backhaul link, the predetermined time interval being shorter than a threshold interval.

In some embodiments, the DL data includes a first type of DL data and a second type of DL data. The first network device 110 may detect the first type of DL data from the second network device 115 in a first period in the first DL backhaul link 140. The first network device 110 may detect the second type of DL data from the second network device 115 in a second period in the first DL backhaul link 140. The second period is shorter than the first period.

In some embodiments, the first network device 110 may transmit a part of UL control information to the second network device 115 in the first UL backhaul link 130. The first network device 110 may also transmit transmitting a further part of the UL control information to the second network device in the assistant UL backhaul link 150 scheduled by the second network node 115.

In some embodiments, the first network device 110 may receive a part of DL control information from the second network device 115 in the first DL backhaul link 140. The first network device 110 may also receive a further part of the DL control information from the second network device 115 in the assistant DL backhaul link 155 scheduled by the first network node 110.

In some embodiments, the first network device 110 may transmit the DL data to the third network device 120 in the second DL backhaul link 145. The second DL backhaul link 145 is scheduled by the first network device 110. The third network device is located in downstream of the first network device 110.

In some embodiments, the first UL backhaul link 130 and the second DL backhaul link 145 operate in one frequency band.

In some embodiments, the first network device 110 may receive the UL data from the third network device 120 in the second UL backhaul link 135. The second UL backhaul link is scheduled by the third network device 120, and the third network device 120 is located in downstream of the first network device 110.

In some embodiments, the first UL backhaul link operates in a frequency band, and the first UL backhaul link operates in a different orthogonal frequency band.

FIG. 11 shows a flowchart of an example method 1100 in accordance with some other embodiments of the present disclosure. The method 1100 can be implemented at the second network device 115 as shown in FIG. 1. For the purpose of discussion, the method 700 will be described with reference to FIG. 1.

At block 1105, the second network device 115 transmits downlink (DL) data to the first network device 110 in the first DL backhaul link 140. The first DL backhaul link 140 is scheduled by the second network device 115. The second network device is located in upstream of the first network device 110.

At block 1110, the second network device 115 receives uplink (UL) data from the first network device in the first UL backhaul link 130. The first UL backhaul link 130 is scheduled by the first network device 110.

In some embodiments, the DL data includes a first type of DL data. The second network device 115 may determine a DL resource for transmitting the first type of DL data in the first DL backhaul link 130. The second network device 115 may transmit, using at least a first part of the DL resource, the first type of DL data to the first network device 110 in the first DL backhaul link 130.

In some embodiments, the DL data further includes a second type of DL data, and the second type being different from the first type. The second network device 115 may allocate a second part of the DL resource for transmitting the second type of DL data in the first DL backhaul link 140. The second part of the DL resource is different from the first part of the DL resource. The second network device 115 may transmit, using the second part of the DL resource, the second type of DL data to the first network device 110 in the first DL backhaul link 140.

In some embodiments, the DL resource includes a first time slot, the first part of the DL resource includes a first set of symbols in the first time slot, and the second part of the DL resource includes a second set of symbols in the first time slot. The second set of symbols is different from the first set of symbols.

In some embodiments, the UL resource further includes a second time slot subsequent to the first time slot, and the first type of DL data includes a first DL data packet of the first type. The second network device 115 may transmit a first portion of the first DL data packet to the first network device 110 in the first set of symbols in the first DL backhaul link 140. The second network device 115 may transmit a second portion of the first DL data packet to the first network device 110 in at least one symbol of the second time slot in the first DL backhaul link 140.

In some embodiments, the second network device 115 may send an indication of the number of DL data packets of the first type to the first network device 110 in a further symbol of the second time slot in the first DL backhaul link 140.

In some embodiments, the second network device 115 may send, using a third part of the DL resource, control information associated with the second type of DL data to the first network device 110 in the first DL backhaul link 140. The control information is to be used by the first network device 110 for receiving the second type of DL data.

In some embodiments, the DL resource is reserved for the first DL backhaul link.

In some embodiments, the second network device 115 may receive, in response to transmitting the second type of DL data, acknowledgement information associated with the second type of DL data from the first network device 110 in a predetermined time interval in the first DL backhaul link. The predetermined time interval is shorter than a threshold interval.

In some embodiments, the UL data includes a first type of UL data and a second type of UL data. The second network device 115 may detect the first type of UL data from the first network device 110 in a first period in the first UL backhaul link 130. The second network device 115 may detect the second type of UL data from the first network device 110 in a second period in the first UL backhaul link 130. The second period is shorter than the first period.

In some embodiments, the second network device 115 may transmit a part of DL control information to the first network device 110 in the first DL backhaul link 140. The second network device 115 may transmit a further part of the DL control information to the first network device 110 in the assistant DL backhaul link 155 scheduled by the first network node 110.

In some embodiments, the second network device 115 may receive a part of UL control information from the first network device 110 in the first UL backhaul link 130. The second network device 115 may receive a further part of the UL control information from the first network device 110 in the assistant UL backhaul link 150 scheduled by the second network node 115.

In some embodiments, the second network device 115 may transmit the UL data to a fourth network device (not shown in FIG. 1) in a third UL backhaul link (not shown in FIG. 1). The third UL backhaul link is scheduled by the second network device 115, and the fourth network device is located in upstream of the second network device 115.

In some embodiments, the first DL backhaul link and the third UL backhaul link operate in one frequency band.

In some embodiments, the second network device 115 may receive the DL data from the fourth network device in a third DL backhaul link (not shown). The third DL backhaul link is scheduled by the fourth network device.

It is to be understood that all operations and features related to the first and second network devices 110 and 115 described above with reference to FIGS. 1-9 are likewise applicable to the methods 1000 and 1100 and have similar effects. For the purpose of simplification, the details will be omitted.

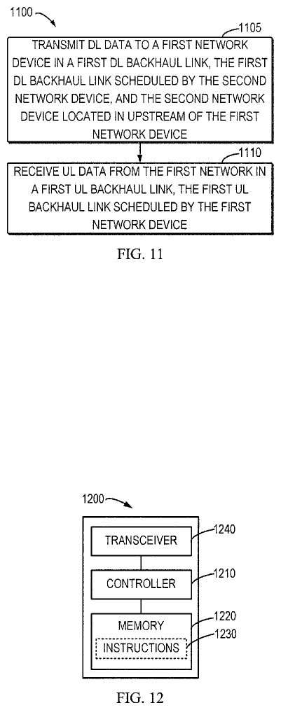

FIG. 12 shows a block diagram of a device 1200 suitable for implementing embodiments of the present disclosure. The device 1200 can be used for implementing a network device, such as, the first network device 110 and/or the second network device 115 as shown in FIG. 1.

As illustrated, the device 1200 comprises a controller 1210, which controls operations and functions of the device 1200. In some embodiments, the controller 1210 may perform various operations, for example, by means of instructions 1230 stored in a memory 1220 coupled to the controller 1210. The memory 1220 may be of any types suitable for local technology environments and may be implemented using any suitable data storage techniques, which includes, but is not limited to, a semiconductor based storage device, a magnetic storage device and system, and an optical storage device and system. Although FIG. 12 only illustrates one memory unit, the device 1200 may comprise several physically distinct memory units.

The controller 1210 may be of any types suitable for the local technology environments and may include, but not limited to, one or more of a general-purpose computer, a special purpose computer, a microcontroller, a digital signal processor (DSP), and a multi-core controller architecture based on controllers. The device may also comprise a plurality of controllers 1210. The controllers 1210 are coupled to the transceiver 1240. The transceiver 1240 may receive and transmit information via one or more antennas, cables or fibers, and/or other components.

When the device 1200 serves as the first network device 110, the controller 1210 and the transceiver 1240 may cooperate to perform the method 1000 as described above with reference to FIG. 10. When the device 1200 serves as the second network device 115, the controller 1210 and the transceiver 1240 may cooperate to perform the method 1100 as described above with reference to FIG. 11. In some embodiments, all acts related to data/information transmission and reception as described above may be performed by the transceiver 1240, while other actions may be performed by the controller 1210, for example. All of the features described with reference to FIGS. 1-11 are applicable to the device 1200 and will not be repeated here.

Generally, various example embodiments of the present disclosure may be implemented in hardware, special purpose circuits, software, logic or any combinations thereof. Some aspects may be implemented in hardware while other aspects may be implemented in firmware or software executed by controllers, microprocessors or other computing devices. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

As an example, embodiments of the present disclosure may be described in the context of machine-executable instructions, which is included in program modules executed in devices on a target physical or virtual processor, for example. In general, program modules comprise routines, programs, libraries, objects, classes, components, data structures, and the like, that perform particular tasks or implement particular abstract data structures. The functionality of the program modules may be combined or split between program modules as desired in various embodiments. Machine-executable instructions for program modules may be executed within a local or distributed device. In a distributed device, program modules may be located in both local and remote storage media.

Computer program codes for carrying out methods of the present disclosure may be written in any combination of one or more programming languages. The computer program codes may be provided to a processor of a general-purpose computer, a special purpose computer or other programmable data processing apparatuses, such that the program codes, when executed by the computer or other programmable data processing apparatuses, cause the functions/operations specified in the flowcharts and/or block diagrams to be implemented. The program codes may be executed entirely on a machine, partly on the machine, as a stand-alone software package, partly on the machine and partly on a remote machine or entirely on the remote machine or server.

In the context of the present disclosure, a machine-readable medium may be any tangible medium that contains or stores programs for or related to an instruction executing system, apparatus or device. The machine-readable medium may be a machine-readable signal medium or a machine-readable storage medium and may include but not limited to an electronic, magnetic, optical, electromagnetic, infrared, or semiconductor system, apparatus or device, or any suitable combination thereof. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination thereof.

Furthermore, although operations are depicted in a particular order, it is to be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-36. (canceled)

37. A method implemented at a first network device, comprising:
transmitting uplink (UL) data to a second network device in a first UL backhaul link, the first UL backhaul link being scheduled by the first network device, and the second network device being located in upstream of the first network device; and
receiving downlink (DL) data from the second network device in a first DL backhaul link, the first DL backhaul link being scheduled by the second network device.

38. The method of claim 37, wherein the UL data includes a first type of UL data, and transmitting the UL data comprises:
determining a UL resource for transmitting the first type of UL data in the first UL backhaul link; and
transmitting, using at least a first part of the UL resource, the first type of UL data to the second network device in the first UL backhaul link.

39. The method of claim 38, wherein the UL data further includes a second type of UL data, the second type being different from the first type, and transmitting the UL data further comprises:
allocating a second part of the UL resource for transmitting the second type of UL data in the first UL backhaul link, the second part of the UL resource being different from the first part of the UL resource; and
transmitting, using the second part of the UL resource, the second type of UL data to the second network device in the first UL backhaul link.

40. The method of claim 39, wherein the UL resource includes a first time slot, the first part of the UL resource includes a first set of symbols in the first time slot, and the second part of the UL resource includes a second set of symbols in the first time slot, the second set of symbols being different from the first set of symbols.

41. The method of claim 40, wherein the UL resource further includes a second time slot subsequent to the first time slot, the first type of UL data includes a first UL data packet of the first type, and transmitting the first type of UL data comprises:
transmitting a first portion of the first UL data packet to the second network device in the first set of symbols in the first UL backhaul link; and
transmitting a second portion of the first UL data packet to the second network device in at least one symbol of the second time slot in the first UL backhaul link.

42. The method of claim 41, further comprising:
sending an indication of the number of UL data packets of the first type to the second network device in a further symbol of the second time slot in the first UL backhaul link.

43. The method of claim 39, further comprising:
sending, using a third part of the UL resource, control information associated with the second type of UL data to the second network device in the first UL backhaul link, the control information to be used by the second network device for receiving the second type of UL data.

44. The method of claim 38, wherein the UL resource is reserved for the first UL backhaul link.

45. The method of claim 39, further comprising:
in response to transmitting the second type of UL data, receiving acknowledgement information associated with the second type of UL data from the second network device in a predetermined time interval in the first DL backhaul link, the predetermined time interval being shorter than a threshold interval.

46. The method of claim 37, wherein the DL data includes a first type of DL data and a second type of DL data, and receiving the DL data comprises:
detecting the first type of DL data from the second network device in a first period in the first DL backhaul link; and
detecting the second type of DL data from the second network device in a second period in the first DL backhaul link, the second period being shorter than the first period.

47. The method of claim 37, further comprising:
transmitting a part of UL control information to the second network device in the first UL backhaul link; and
transmitting a further part of the UL control information to the second network device in an assistant UL backhaul link scheduled by the second network node.

48. The method of claim 37, further comprising:
receiving a part of DL control information from the second network device in the first DL backhaul link; and
receiving a further part of the DL control information from the second network device in an assistant DL backhaul link scheduled by the first network node.

49. The method of claim 37, further comprising:
transmitting the DL data to a third network device in a second DL backhaul link, the second DL backhaul link being scheduled by the first network device, and the third network device being located in downstream of the first network device.

50. The method of claim 49, wherein the first UL backhaul link and the second DL backhaul link operate in one frequency band.

51. The method of claim 37, further comprising:
receiving the UL data from a third network device in a second UL backhaul link, the second UL backhaul link being scheduled by the fourth network device, and the fourth network device being located in downstream of the first network device.

52. The method of claim 37, wherein the first UL backhaul link operates in a frequency band, and the first UL backhaul link operates in a different orthogonal frequency band.

53. A network device, comprising:
a processor; and
a memory including instructions, the instructions, when executed by the processor, causing the network device to transmit uplink (UL) data to a second network device in a first UL backhaul link, the first UL backhaul link being scheduled by the network device, and the second network device being located in upstream of the network device; and
to receive downlink (DL) data from the second network device in a first DL backhaul link, the first DL backhaul link being scheduled by the second network device.

54. A non-transitory computer readable storage medium tangibly storing computer program thereon, the computer program including instructions which, when executed on at least one processor, cause the at least one processor to transmit uplink (UL) data from a first network device to a second network device in a first UL backhaul link, the first UL backhaul link being scheduled by the first network device, and the second network device being located in upstream of the first network device; and
to receive downlink (DL) data from the second network device in a first DL backhaul link, the first DL backhaul link being scheduled by the second network device.
